(19) United States
(12) Patent Application Publication
(10) Pub. No.: US 2017/0295287 A1
(43) Pub. Date: Oct. 12, 2017

(54) MANUFACTURING METHOD OF SENSOR UNIT AND READING APPARATUS

(71) Applicant: CANON COMPONENTS, INC., Kodama-gun (JP)

(72) Inventors: Hideo KIYOTA, Saitama (JP); Yohei HIRATSUKA, Saitama (JP); Takashi KOBE, Saitama (JP); Hiroyuki FUJIMURA, Saitama (JP)

(21) Appl. No.: 15/479,551

(22) Filed: Apr. 5, 2017

(30) Foreign Application Priority Data
Apr. 8, 2016 (JP) 2016-078187
Mar. 21, 2017 (JP) 2017-054624

(51) Int. Cl. H04N 1/00; H04N 1/028; H04N 1/10; G01J 1/44

(52) U.S. Cl. CPC H04N 1/00557; G01J 1/44; H04N 1/02855; H04N 1/1061; H04N 2201/0081; H04N 2201/0094

(57) ABSTRACT

Provided is a manufacturing method of a sensor unit, the sensor unit including: a rod-shaped light condenser that condenses light from an original; a frame that houses the light condenser; and a plurality of urging members that urge the light condenser toward the frame and mount the light condenser on the frame, the manufacturing method including: a light condenser housing step of housing the light condenser in the frame; and an urging member mounting step of pressing, by an assembly machine, the plurality of urging members against the frame.

### CROSS-REFERENCE TO RELATED APPLICATIONS

This application is based upon and claims the benefit of priority of the prior Japanese Patent Application No. 2016-078187, filed on Apr. 8, 2016, and the Japanese Patent Application No. 2017-054624, filed on Mar. 21, 2017, the entire contents of which are incorporated herein by reference.

### BACKGROUND OF THE INVENTION

### Field of the Invention

The present invention relates to a manufacturing method of a senor unit and a reading apparatus.

### Description of the Related Art

There is a known image sensor unit that causes an image sensor to focus light from a linearly illuminated object to read an image of the illuminated object. Patent Document 1 discloses an image sensor module that houses a lens unit in a slit of a case, wherein the lens unit couples, with a sensor chip, linear light reflected by a light source. The lens unit disclosed in Patent Document 1 is housed in the slit and fixed by an adhesive.

However, there is a problem that the image sensor module cannot be easily manufactured when the adhesive is used to fix the lens unit as in the image sensor module of Patent Document 1. Specifically, when the adhesive is used for the fixation, an appropriate amount of adhesive needs to be applied. When the amount of adhesive is too large, the adhesive sticks out and affects other members. When the amount of adhesive is too small, the lens unit cannot be sufficiently fixed. Furthermore, the viscosity of the adhesive may vary depending on the manufactured lot or the temperature, and management of the adhesive is necessary. Furthermore, application time for applying the adhesive and curing time for curing the adhesive are necessary, and it is difficult to improve the production efficiency.

Patent Document 1

Japanese Laid-open Patent Publication No. 2009-200913

### SUMMARY OF THE INVENTION

The present invention has been made in view of the problems, and an object of the present invention is to provide a manufacturing method and the like of a sensor unit that can easily mount a light condenser on a frame.

The present invention provides a manufacturing method of a sensor unit, the sensor unit including: a rod-shaped light condenser that condenses light from an illuminated object; a frame that houses the light condenser; and a plurality of urging members that urge the light condenser toward the frame and mount the light condenser on the frame, the manufacturing method including: a light condenser housing step of housing the light condenser in the frame; and an urging member mounting step of pressing, by an assembly machine, the plurality of urging members against the frame.

The present invention provides a reading apparatus including: a transparent plate for placing an illuminated object; and a sensor unit that reads the illuminated object through the transparent plate, the sensor unit including: a rod-shaped light condenser that condenses light from the illuminated object; a frame that houses the light condenser; and a plurality of urging members that urge the light condenser toward the frame and mount the light condenser on the frame, the reading apparatus including moving means for moving at least one of the transparent plate and the sensor unit, wherein the frame comprises sliding convex portions between a position of arrangement of the light condenser and an end, and a distance between the urging members and the transparent plate is longer than a distance between the sliding convex portions and the transparent plate.

### BRIEF DESCRIPTION OF THE DRAWINGS

FIG. 1 is a sectional view of an image sensor unit 1 of a first embodiment;

FIG. 2 is a perspective view illustrating an appearance of an MFP 100 including the image sensor unit 1;

FIG. 3 is a schematic view illustrating a structure of an image forming portion 113 of the MFP 100;

FIG. 4 is an exploded perspective view of the image sensor unit 1;

FIG. 5 is an exploded perspective view of part of the image sensor unit 1;

FIG. 6 is a perspective view of an urging member 50;

FIG. 7 is a perspective view of a holding member 70;

FIG. 8 is a view illustrating an example of a frame positioning step;

FIG. 9 is a view illustrating an example of a light condenser housing step;

FIG. 10 is a perspective view illustrating a configuration of an assembly machine 90;

FIG. 11 is a perspective view illustrating a configuration of part of the assembly machine 90;

FIG. 12 is a sectional view of a frame 10 provided with the urging member 50;

FIG. 13 is a view illustrating an example of a holding member mounting step;

FIG. 14 is a sectional view of an image sensor unit 2 of a second embodiment; and

FIG. 15 is a perspective view of a sliding portion 130.

### DETAILED DESCRIPTION OF THE PREFERRED EMBODIMENTS

Embodiments of the present invention will now be described in detail with reference to the drawings.

### First Embodiment

The present embodiment provides an image sensor unit (a sensor unit) 1 as well as an image reading apparatus (reading apparatus) and an image forming apparatus to which the image sensor unit 1 is applied. In the image reading apparatus and the image forming apparatus, the image sensor unit 1 emits light to an original P as an illuminated object, and reflected light is converted to an electric signal to read an image.

In the following description, three-dimensional directions will be indicated by X, Y, and Z arrows. The X direction denotes a longitudinal direction of an image sensor described later and can be called, for example, a main-scan direction. The Y direction denotes a sub-scan direction perpendicular to the main-scan direction. The Z direction denotes a perpendicular direction (vertical direction).

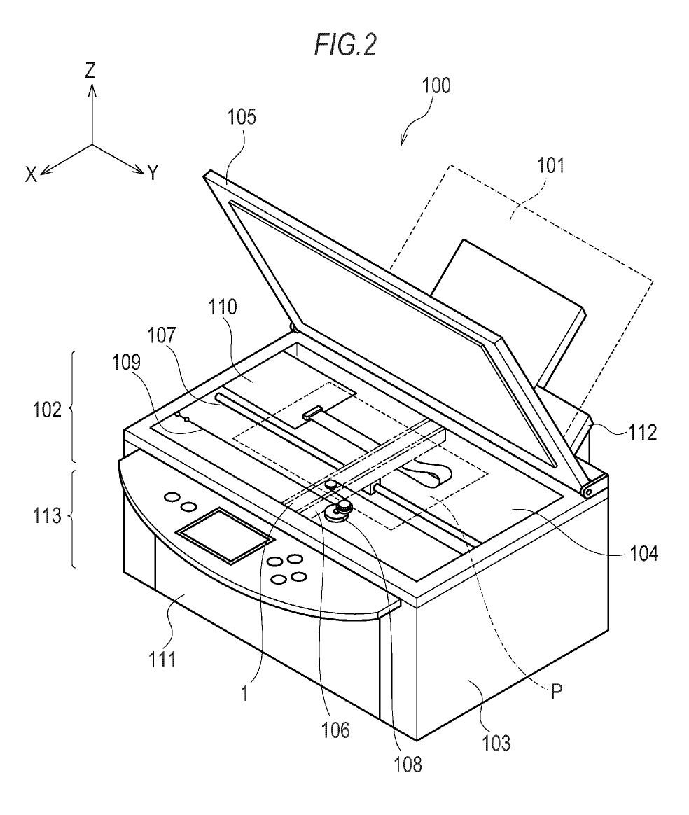

A structure of a multi-function printer (MFP) as an example of the image reading apparatus or the image forming apparatus according to the present embodiment will be described with reference to FIG. 2. FIG. 2 is a perspective view illustrating an appearance of an MFP 100. As illustrated in FIG. 2, the MFP 100 includes: an image reading portion 102 as image reading means for reading the reflected light from the original P; and an image forming portion 113 as image forming means for forming (printing) an image of the original P on a sheet 101 (recording paper) as a recording medium.

The image reading portion 102 has a function of a so-called image scanner and is configured, for example, as follows. The image reading portion 102 includes: a housing 103; a platen glass 104 as an original placing portion made of, for example, a glass transparent plate; and a platen cover 105 that can be freely opened and closed relative to the housing 103 so as to be able to cover the original P.

The housing 103 houses the image sensor unit 1 including an illumination apparatus, a holding member 106, a slide shaft 107, a drive motor 108, a wire 109, a signal processing portion 110, a recovery unit 111, a paper feeding tray 112, and the like.

The image sensor unit 1 is, for example, a contact image sensor (CIS) unit. The holding member 106 surrounds and holds the image sensor unit 1. The slide shaft 107 guides the holding member 106 in the sub-scan direction along the platen glass 104. The drive motor 108 is movement means for relatively moving the image sensor unit 1 and the original P, and specifically, the drive motor 108 moves the wire 109 attached to the holding member 106. The recovery unit 111 can be freely opened and closed relative to the housing 103 and is configured to recover the printed sheet 101. The paper feeding tray 112 houses the sheet 101 in a predetermined size.

In the image reading portion 102 with the configuration, the drive motor 108 moves the image sensor unit 1 in the sub-scan direction along the slide shaft 107. In this case, the image sensor unit 1 optically reads the original P placed on the platen glass 104 to convert the light to an electric signal to perform reading operation of the image.

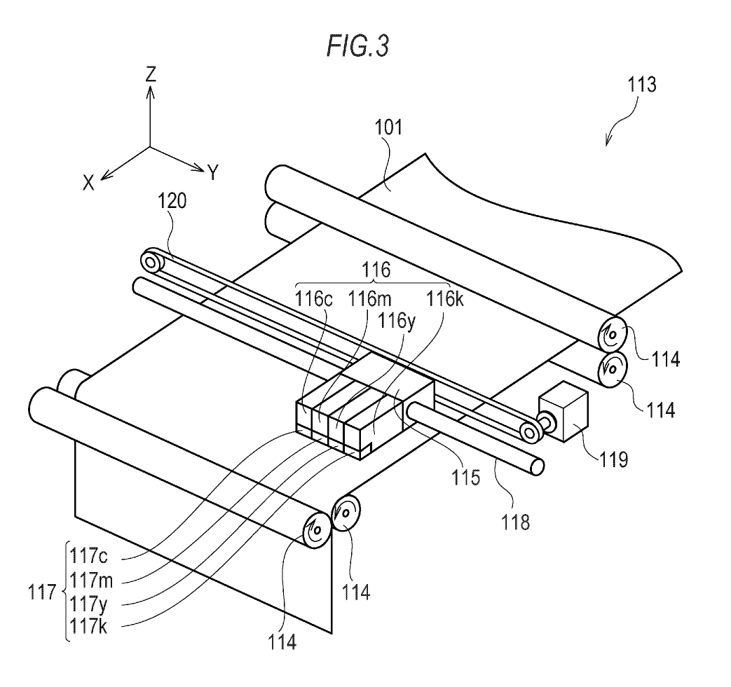

FIG. 3 is a schematic view illustrating a structure of the image forming portion 113.

The image forming portion 113 has a function of a so-called printer and is configured, for example, as follows. The image forming portion 113 is housed in the housing 103 and includes conveyance rollers 114 and a recording head 115 as illustrated in FIG. 3. The recording head 115 includes, for example: ink tanks 116 (116c, 116m, 116y, and 116k) with cyan C, magenta M, yellow Y, and black K inks; and discharge heads 117 (117c, 117m, 117y, and 117k) provided to the ink tanks 116, respectively. The image forming portion 113 includes a recording head slide shaft 118, a recording head drive motor 119, and a belt 120 attached to the recording head 115.

In the image forming portion 113 with the configuration described above, the conveyance rollers 114 convey the sheet 101 supplied from the paper feeding tray 112 to the recording position. The recording head drive motor 119 mechanically moves the belt 120, and the recording head 115 performs printing on the sheet 101 based on an electric signal while moving in a printing direction (main-scan direction) along the recording head slide shaft 118. The operation is repeated until the printing is finished, and the conveyance rollers 114 eject the printed sheet 101 to the recovery unit 111.

Although the inkjet-type image forming apparatus has been described as the image forming portion 113, the type can be any type, such as an electrophotographic type, a thermal transfer type, and a dot impact type.

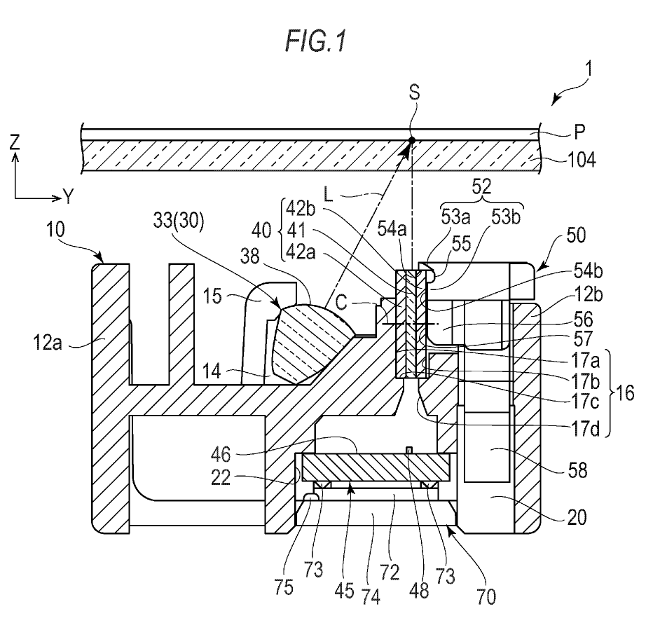

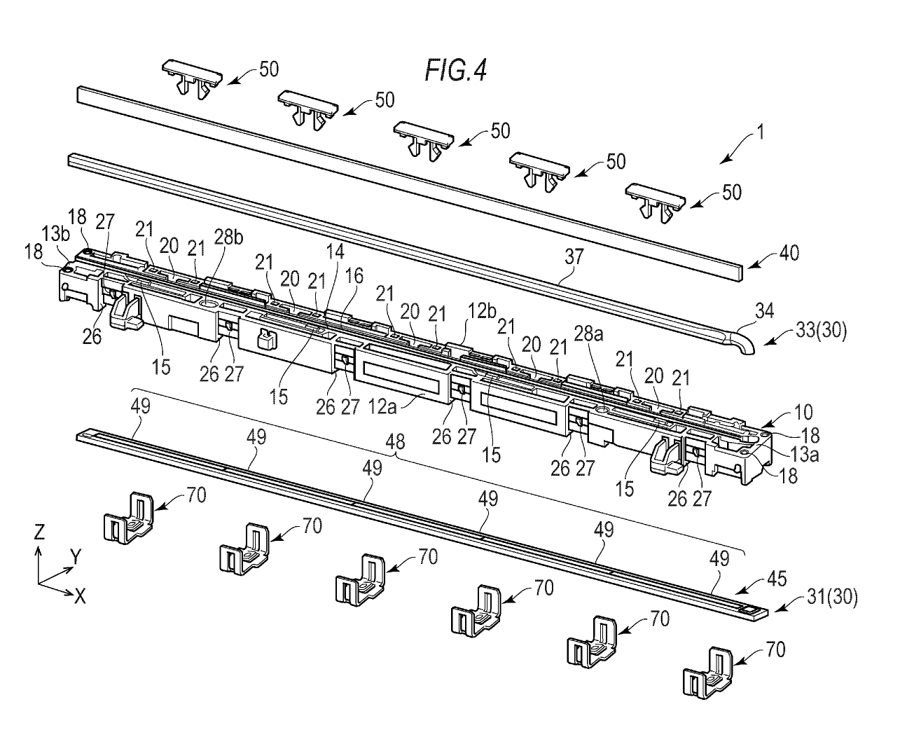

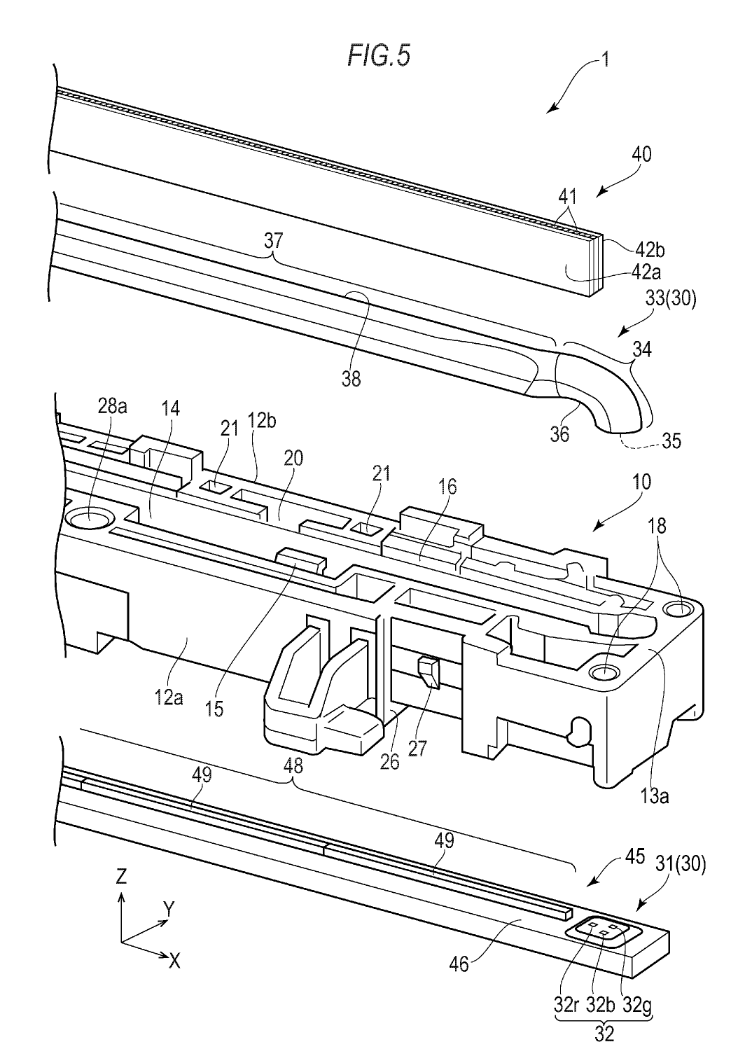

Next, a configuration of the image sensor unit 1 of the present embodiment will be described with reference to the drawings. FIG. 1 is a sectional view of the image sensor unit 1 cut in the sub-scan direction. FIG. 4 is an exploded perspective view of the image sensor unit 1. FIG. 5 is an exploded perspective view illustrating part of the image sensor unit 1.

The image sensor unit 1 includes a frame 10, an illumination portion 30, a light condenser 40, a sensor substrate 45, an image sensor (a sensor or a line sensor) 48, urging members 50 as stoppers, holding members 70, and the like. The illumination portion 30 can be caused to function as an illumination apparatus. Among the constituent members, the frame 10, the illumination portion 30, the light condenser 40, the sensor substrate 45, and the image sensor 48 have lengths according to the dimension in the main-scan direction of the original P to be read.

The frame 10 is a housing member that houses the constituent members of the image sensor unit 1. An outer wall portion 12a on one side in the sub-scan direction, an outer wall portion 12b on the other side in the sub-scan direction, a side wall portion 13a on one side in the main-scan direction, and a side wall portion 13b on the other side in the main-scan direction form the outer shape of the frame 10 in a substantially rectangular solid shape with the main-scan direction as a longitudinal direction. The inside of the frame 10 is formed to be able to position and support the constituent members.

As illustrated in FIG. 1, a light guide housing portion 14 that houses a light guide 33 described later of the illumination portion 30 is formed in the main-scan direction at substantially the center on the upper side of the frame 10. A plurality of (for example, four) locking claws 15 for engaging the light guide 33 are formed on the light guide housing portion 14 at intervals in the main-scan direction. The locking claws 15 are elastically deformed, and the light guide 33 is detachably engaged.

A light condenser housing portion 16 that houses the light condenser 40 is formed in the main-scan direction at a position adjacent to the light guide housing portion 14 of the frame 10. As illustrated in FIG. 1, the light condenser housing portion 16 is formed in a groove shape by an inner wall portion 17a on one side in the main-scan direction, an inner wall portion 17b on the other side in the main-scan direction, and a bottom part 17c. The wall surfaces of the inner wall portion 17a and the inner wall portion 17b are parallel and face each other, and there is a gap that allows housing the light condenser 40. A passage hole 17d for passing the light emitted from the light condenser 40 toward the image sensor 48 is formed on the bottom part 17c in the main-scan direction. As illustrated in FIG. 4, both ends of the light condenser housing portion 16 in the main-scan direction are blocked by the side wall portions 13a and 13b. The side wall portions 13a and 13b include a plurality of (for example, two) holes 18 on upper surfaces.

Engaged portions 20 engaged with engagement portions 58 described later of the urging member 50 are formed in a concave shape from the upper side of the frame 10, at positions close to the light condenser housing portion 16 of the frame 10. As illustrated in FIG. 4, a plurality of (for example, five) engaged portions 20 are formed at intervals in the main-scan direction. The upper part of the inner wall portion 17b is not provided at positions adjacent to the engaged portions 20 in the light condenser housing portion 16, and the light condenser housing portion 16 and the engaged portions 20 communicate. On both sides of the engaged portions in the main-scan direction, positioning holes 21 are formed in a concave shape from the upper side.

As illustrated in FIG. 1, a substrate housing portion 22 that houses the sensor substrate 45 is formed on the lower side of the frame 10 throughout the main-scan direction.

On each of the outer wall portions 12a and 12b of the frame 10, a plurality of (for example, six) fitting groove portions 26 fitted with pairs of sandwiching portions 76a and 76b described later of the holding members 70 are formed at intervals in the main-scan direction. The dimension (groove width) of the fitting groove portions 26 in the main-scan direction is substantially the same as the dimension of the holding members 70 in the main-scan direction. Held portions 27 in a substantially triangular shape for engaging holding holes 77 described later of the holding members 70 protrude and are formed in the fitting groove portions 26.

On the frame 10, insertion holes 28a and 28b as inserted portions penetrating from the upper surface to the lower surface are formed at spaced positions in the longitudinal direction. The insertion hole 28a is circular and is positioned on one side of the frame 10 in the longitudinal direction. On the other hand, the insertion hole 28b is a hole elongated in the longitudinal direction of the frame 10 and is positioned on the other side of the frame 10 in the longitudinal direction. The insertion holes 28a and 28b may not penetrate through the frame 10.

The frame 10 is formed by, for example, a light-blocking resin material colored in black. The resin material can be, for example, polycarbonate.

The illumination portion 30 linearly illuminates the original P. The illumination portion 30 of the present embodiment includes a light source 31 and the light guide 33.

The light source 31 emits light to illuminate the original P through the light guide 33. As illustrated in FIG. 5, the light source 31 can be a so-called top-view surface-mount LED package in which LED chips 32 as light emitting elements are mounted on the surface. The light source 31 is mounted on a mounting surface 46 on one side of the sensor substrate 45 in the longitudinal direction and emits light upward. The light source 31 is provided with a plurality of (for example, three) LED chips 32r, 32g, and 32b sealed by a transparent resin. The LED chips 32r, 32g, and 32b emit visible light with red, green, and blue (hereinafter, also called RGB) emission wavelengths, respectively. LED chips that emit light with emission wavelengths of infrared light or ultraviolet light instead of the visible light may be used in order to read an image printed on the original P using invisible ink.

The light guide 33 linearly emits the light emitted from the light source 31 toward the original P. In the light guide 33, a curved portion 34 curved on one side and a rod-shaped linear portion 37 extending toward the other side with the main-scan direction as a longitudinal direction are integrally formed.

The curved portion 34 guides the light from the light source 31 to the linear portion 37. As illustrated in FIG. 5, an incident surface 35 that receives the light from the light source 31 is formed on an end surface of the curved portion 34. The incident surface 35 is substantially parallel to the light source 31 and faces the light source 31 at a slight interval such that the light from the light source 31 is incident on the light guide 33 at a good yield. A reflection surface 36 that reflects the light entered from the incident surface 35 toward the linear portion 37 is formed on the peripheral surface of the curved portion 34.

The linear portion 37 linearly emits the light guided from the curved portion 34 toward the original P. An emission surface 38 that emits the light guided from the curved portion 34 toward the original P is formed on the surface of the linear portion 37 opposing the original P. As illustrated in FIG. 1, the emission surface 38 is formed in, for example, an arc shape that is convex upward in order to condense the light on a reading line S of the original P. The surfaces of the linear portion 37 other than the emission surface 38 function as reflection surfaces that propagate the light guided from the curved portion 34 to the other side of the linear portion 37 or that reflect the light toward the emission surface 38.

The light guide 33 is formed by, for example, an acrylic transparent resin material.

The light condenser 40 condenses the light including image information from the original P and forms an image on the image sensor 48. Here, the upper surface of the light condenser 40 is a light entering surface that imports the light, and the lower surface is a light emission surface that emits the imported light. The light condenser 40 has an elongated shape with a longitudinal direction and can be, for example, a rod lens array. The rod lens array is one in which a plurality of rod lens are arranged in the longitudinal direction. The longitudinal direction may be called main-scan direction. As illustrated in FIG. 5, a plurality of rod lenses 41 as image forming elements of an erect equal magnification imaging type are arranged such that the optical axes are parallel, and the rod lenses 41 are sandwiched and coupled by a plate member 42a from one side in the sub-scan direction and a plate member 42b from the other side in the light condenser 40. The rod lenses 41 are formed by, for example, glass or a transparent resin material. The plate member 42a and the plate member 42b are formed by, for example, a glass epoxy resin and function as binder portions that hold the rod lenses 41. In the light condenser 40, the plurality of rod lenses 41 are coupled by filling a black silicone resin between the plate member 42a and the plate member 42b to remove flare light.

The light condenser 40 is inserted into the light condenser housing portion 16 of the frame 10 from the upper side and is housed in the light condenser housing portion 16. The light condenser 40 is not limited to the configuration as long as an image can be formed on the image sensor 48. The light condenser 40 can be an optical member with various conventionally well-known light condensing functions, such as various micro-lens arrays.

In the sensor substrate 45, the light source 31, the image sensor 48, a driver circuit that causes the light source 31 to emit light or drives the image sensor 48, and the like are mounted on the mounting surface 46. The sensor substrate 45 is formed in a planar shape with the main-scan direction as a longitudinal direction.

The image sensor 48 receives the light formed by the light condenser 40 and converts the light to an electric signal to read the image information. The image sensor 48 is arranged on the lower side of the light condenser 40. As illustrated in FIG. 4, a predetermined number of image sensor ICs 49 including a plurality of light receiving elements (the light receiving elements may be called photoelectric conversion elements) according to the resolution of reading of the image sensor unit 1 are linearly arranged in the main-scan direction on the mounting surface 46 of the sensor substrate 45 and mounted on the image sensor 48. The image sensor 48 is not limited to the configuration as long as the light reflected from the original P can be converted to an electric signal. The image sensor ICs 49 can be various conventionally well-known image sensor ICs.

The urging members 50 are mounted on the frame 10 to urge and fix the light condenser 40 to the frame 10. The urging members 50 urge the light condenser 40, and the light condenser 40 is held without being separated from the inside of the light condenser housing portion 16. As illustrated in FIG. 4, a plurality of (for example, five) urging members 50 are mounted at constant intervals in the longitudinal direction of the frame 10. The urging members 50 are formed by, for example, a resin material.

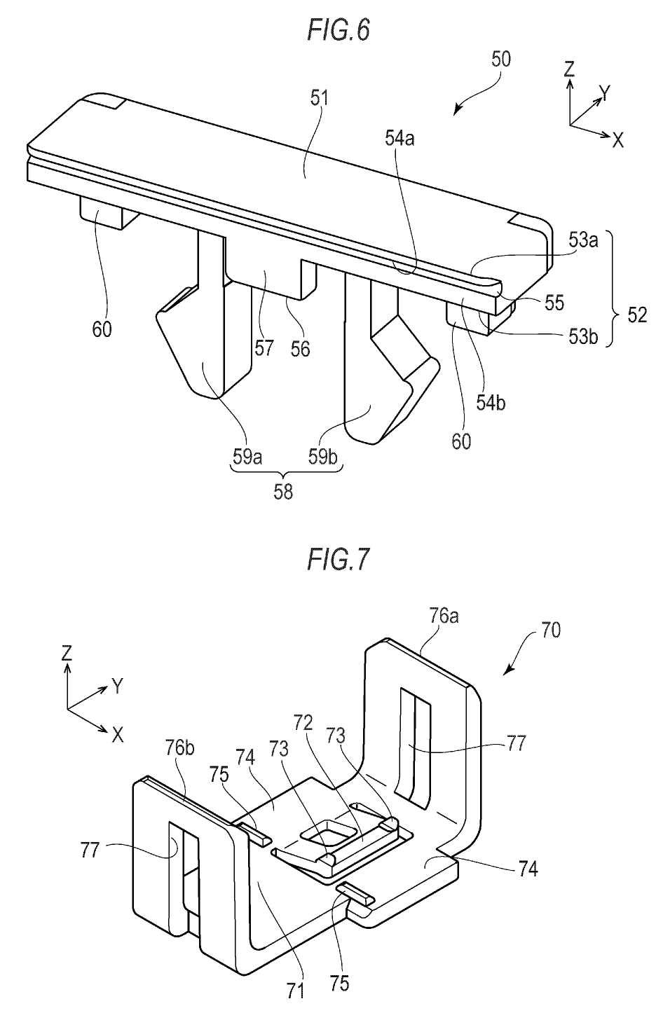

FIG. 6 is a perspective of the urging member 50.

The urging member 50 includes a body portion 51 as a flange portion, the engagement portion 58, and positioning pieces 60.

The body portion 51 has a planar shape in the main-scan direction and includes, at an end on one side in the sub-scan direction, an abutment portion that abuts the light condenser 40. The abutment portion 52 includes: a first support portion 53a coming into contact with the upper surface of the plate member 42b of the light condenser 40; and a second support portion 53b coming into contact with the outer surface of the plate member 42b. A first support surface 54a is formed on the lower surface of the first support portion 53a, and the first support portion 53a comes into contact with the upper surface of the plate member 42b through the first support surface 54a. A second support surface 54b in the vertical direction is formed on the second support portion 53b, and the second support portion 53b comes into contact with the outer surface of the plate member 42b through the second support surface 54b. The first support surface 54a and the second support surface 54b are orthogonal to each other.

A concave portion 55 dug toward the inside of the body portion 51 is formed between the first support surface 54a and the second support surface 54b. When the urging member 50 is manufactured by injection molding, a slightly outward swell is generated between the first support surface 54a and the second support surface 54b due to the characteristics of the mold, and molding of an orthogonal corner is difficult in some cases. Therefore, the formation of the concave portion 55 can perform molding without the generation of the outward swell between the first support surface 54a and the second support surface 54b.

The body portion 51 also includes a wall portion integral with the lower end of the second support portion 53b and protruding downward from the center in the main-scan direction. A wall surface 57 continuous with the second support surface 54b is formed on the wall portion 56.

The engagement portion 58 engages with the engaged portion 20 of the frame 10. The engagement portion 58 includes a pair of engagement pieces 59a and 59b facing downward from the lower surface of the body portion 51. The tips of the pair of engagement pieces 59a and 59b are tapered, and the centers are expanded in opposite directions. The pair of engagement pieces 59a and 59b are elastically deformed in directions approaching each other when external force is applied, and the pair of engagement pieces 59a and 59b return to the original state away from each other when the external force is no longer applied.

The positioning pieces 60 are inserted into the positioning holes 21 of the frame 10. Here, two positioning pieces 60 are formed across the engagement portion 58, at an interval in the main-scan direction.

The holding members 70 are mounted on the frame to hold the sensor substrate 45 housed in the substrate housing portion 22. As illustrated in FIG. 4, a plurality of (for example, six) holding members 70 are mounted at constant intervals in the longitudinal direction of the frame 10.

FIG. 7 is a perspective view of the holding member 70.

The holding member 70 is formed in a substantially C-shape as viewed in the main-scan direction and includes a holding body portion 71, the pair of sandwiching portions 76a and 76b, and the holding holes 77. The holding member 70 is formed by, for example, a resin material.

In the holding body portion 71, a substrate urging portion 72 protruding upward is integrally formed at substantially the center, more specifically, at a position slightly biased to the other side in the sub-scan direction. The substrate urging portion 72 is elastically deformed in the vertical direction. Two projections 73 protruding upward are formed at the tips of the substrate urging portion 72, at positions separated in the sub-scan direction. The holding body portion 71 includes two interval holding portions 74 extending in opposite directions from both ends in the main-scan direction. Projections 75 protruding upward are formed on the upper surfaces of the two interval holding portions 74. Here, one of the projections 73 of the substrate urging portion 72 and the two projections 75 on the upper surfaces of the interval holding portions 74 are arranged substantially linearly in the main-scan direction when the holding member 70 is viewed from above.

The pair of sandwiching portions 76a and 76b are formed to protrude upward from both ends of the holding body portion 71. The holding hole 77 is formed on each of the pair of sandwiching portions 76a and 76b.

Next, a manufacturing method of the image sensor unit 1 of the present embodiment will be described.

The manufacturing method of the image sensor unit of the present embodiment includes the following steps 1 to 7. The light source 31, the image sensor 48, the drive circuit, and the like are mounted in advance on predetermines positions of the sensor substrate 45.

### (Step 1)

Step 1 is a frame placement step of placing the frame 10 on a placing table 80.

An automatic assembly machine installed in the stage of step 1 performs the work of step 1.

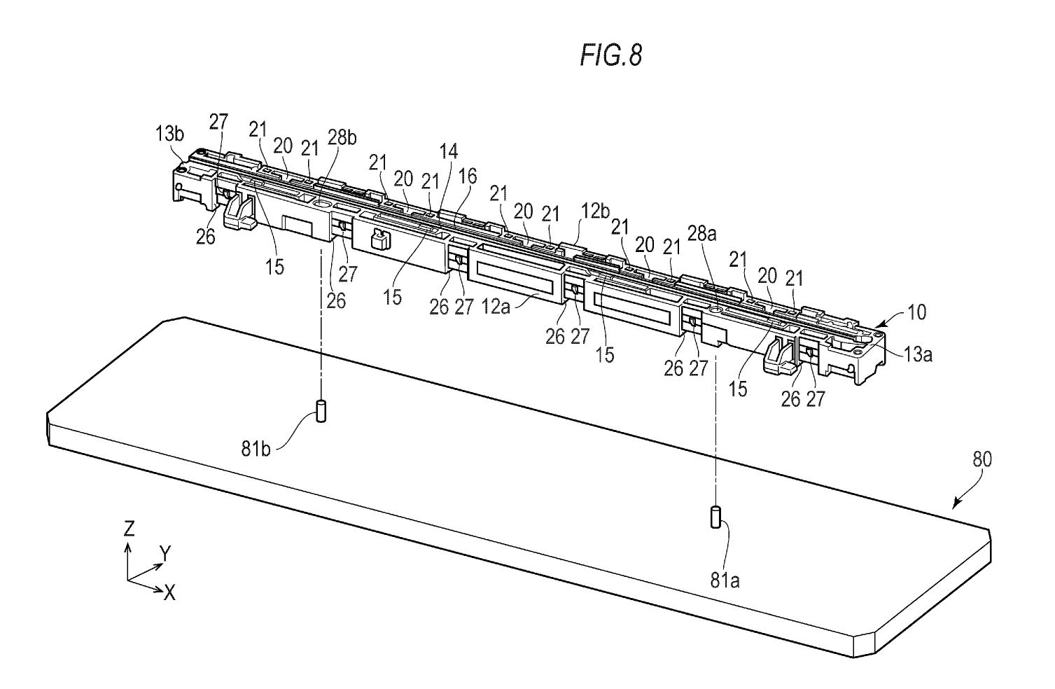

FIG. 8 is a view illustrating an example of a frame positioning step.

The placing table 80 has a planar shape longer than the dimension of the frame 10 in the longitudinal direction to allow placing the frame 10. On the surface of the placing table 80, a plurality of (two) pins 81a and 81b as insertion portions project upward and are arranged at spaced positions in the longitudinal direction of the placing table 80. The pins 81a and 81b have a columnar shape that allows insertion into the insertion holes 28a and 28b of the frame 10. When the pin 81a is inserted into the insertion hole 28a of the frame 10, the pin 81a and the insertion hole 28a are fitted, and there is almost no clearance. When the pin 81b is inserted into the insertion hole 28b of the frame 10, there is a clearance between the pin 81b and the insertion hole 28b in the longitudinal direction of the frame 10, because the opening of the insertion hole 28b is long in the longitudinal direction of the frame 10. Therefore, the insertion hole 28b and the pin 81b can relatively move in the longitudinal direction of the frame 10. However, the pin 81a and the insertion hole 28a are actually fitted, and the insertion hole 28b and the pin 81b cannot relatively move. On the other hand, there is almost no clearance between the pin 81b and the insertion hole 28b in the direction orthogonal to the longitudinal direction of the frame 10.

In step 1, the frame 10 is brought close to the placing table 80 with the lower surface of the frame and the placing table 80 facing each other, and the pins 81a and 81b are inserted into the insertion holes 28a and 28b, respectively, to position and place the frame 10 on the placing table 80. The automatic assembly machine installed in the stage of step 1 performs the work of step 1.

Here, the insertion hole 28b is a hole elongated in the longitudinal direction of the frame 10, and the pin 81b can be easily inserted into the insertion hole 28b even if the frame 10 is expanded or contracted due to an accuracy error of the frame 10 or due to the environment temperature. In this case, although there is a clearance between the pin 81b and the insertion hole 28b in the longitudinal direction, the pin 81a and the insertion hole 28a are fitted, and the frame 10 and the placing table 80 can be accurately positioned in the longitudinal direction. There is almost no clearance between the pin 81b and the insertion hole 28b in the direction orthogonal to the longitudinal direction, and the frame 10 and the placing table 80 can be accurately positioned in the direction orthogonal to the longitudinal direction.

When step 1 is finished, the placing table 80 is conveyed to the next stage.

### (Step 2)

Step 2 is a light condenser housing step of housing the light condenser 40 in the light condenser housing portion 16 of the frame 10.

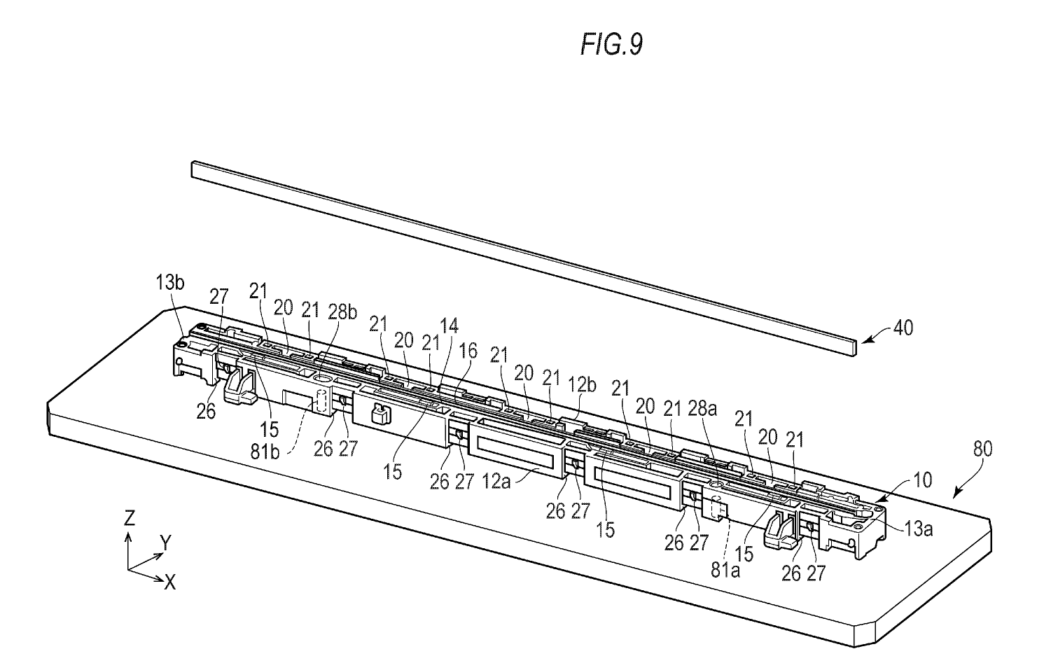

FIG. 9 is a view illustrating an example of the light condenser housing step.

In step 2, the light condenser 40 is inserted toward the light condenser housing portion 16 of the frame 10 from above to house the light condenser 40 in the light condenser housing portion 16. An automatic assembly machine installed in the stage of step 2 performs the work of step 2. The frame 10 is accurately positioned on the placing table 80 in the longitudinal direction of the frame 10 and the direction orthogonal to the longitudinal direction, and the light condenser 40 can be easily housed in the light condenser housing portion 16.

When step 2 is finished, the placing table 80 is conveyed to the next stage.

### (Step 3)

Step 3 is an urging member mounting step of mounting the urging members 50 on the frame 10.

An automatic assembly machine installed in the stage of step 3 performs the work of step 3.

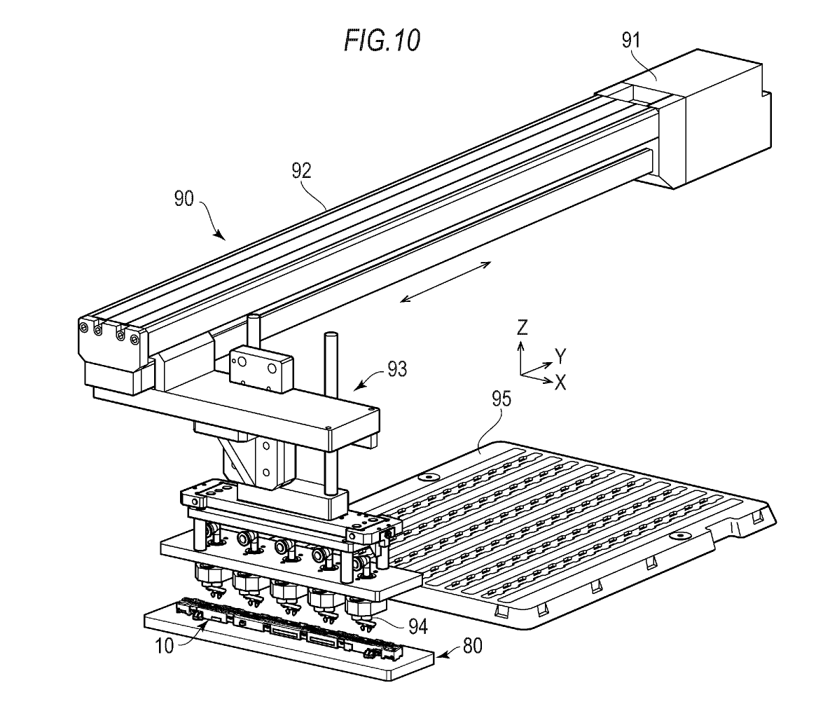

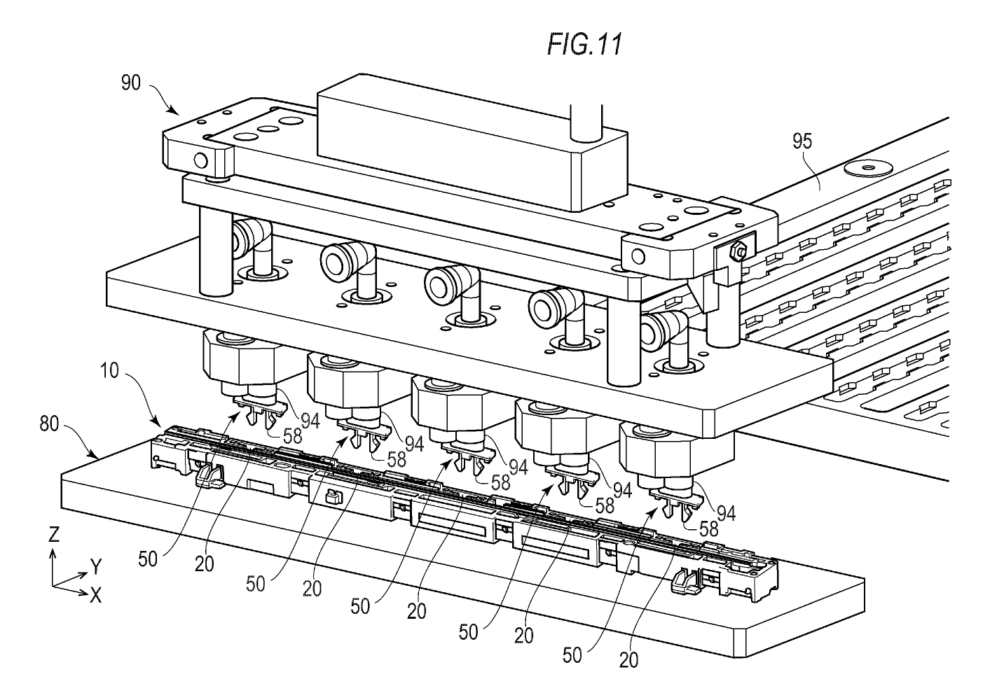

FIG. 10 is a perspective view illustrating a configuration of an assembly machine 90. FIG. 11 is a perspective view illustrating a configuration of part of the assembly machine 90.

The assembly machine 90 includes a horizontal driving portion 91, a vertical driving portion 93, and a plurality of pressing portions 94. The horizontal driving portion 91 moves the vertical driving portion 93 in the horizontal direction along a guide portion 92, more specifically, the direction orthogonal to the longitudinal direction of the frame placed on the placing table 80. The vertical driving portion 93 moves the plurality of pressing portions 94 in the vertical direction. The pressing portion 94 holds the urging members 50 before mounting and mounts the urging members 50 on the frame 10. As illustrated in FIG. 11, the assembly machine 90 includes a plurality of (for example, five) pressing portions 94 equivalent to the number of urging members 50 mounted on the frame 10. The plurality of pressing portions 94 are linearly arranged at the same intervals as the intervals between the engaged portions 20 of the frame 10. The pressing portions 94 include suction holes at positions in contact with the urging members 50, and suction hoses are connected to the suction holes. The pressing portions 94 hold the urging members 50 by sucking the urging members 50 through the suction hoses while the pressing portions 94 are in contact with the surfaces of the body portions 51 of the urging members 50. On the other hand, the pressing portions 94 release the urging members 50 by stopping to suck the urging members 50.

A tray 95 provided with the plurality of urging members 50 before mounting is installed near the conveyed frame 10.

In step 3, the horizontal driving portion 91 moves the vertical driving portion 93 in the horizontal direction, toward the position of the tray 95. The vertical driving portion 93 lowers the plurality of pressing portions 94 toward the plurality of urging members 50 arranged on the tray 95. The plurality of pressing portions 94 hold the plurality of urging members 50 by sucking the urging members 50 while the pressing portions 94 are in contact with the body portions 51 of the urging members 50.

Next, while the vertical driving portion 93 raises the pressing portions 94 holding the urging members 50, the horizontal driving portion 91 moves the vertical driving portion 93 in the horizontal direction to right above the frame 10. Next, the vertical driving portion 93 lowers the plurality of pressing portions 94 at the same time or substantially at the same time to press the engagement portions 58 of the urging members 50 held by the plurality of pressing portions 94 toward the engaged portions 20 of the frame 10, and the engagement portions 58 are engaged with the engaged portions 20. Therefore, the plurality of urging members 50 are simultaneously or substantially simultaneously mounted on the frame 10 all at once. The positioning pieces 60 of the urging members 50 are inserted into the positioning holes 21 of the frame 10.

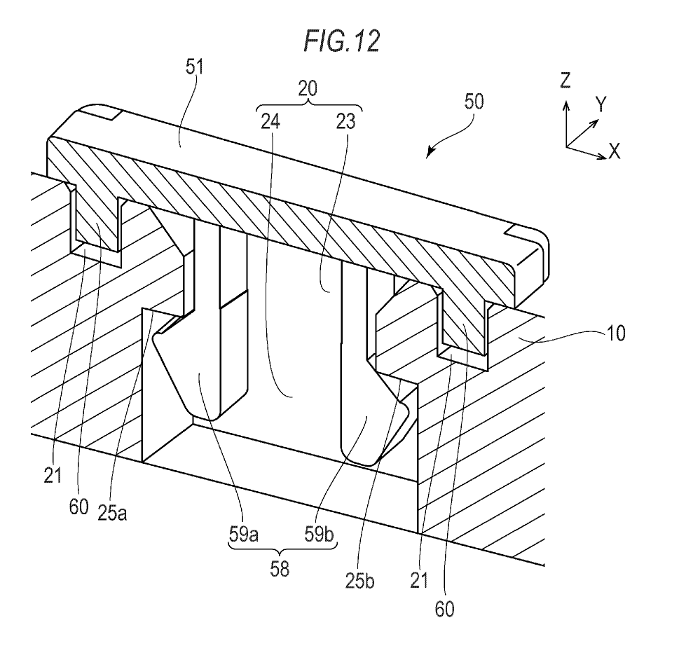

Here, the state in which the urging members 50 are mounted on the frame 10 will be described with reference to FIG. 12. FIG. 12 is a sectional view of the frame 10 provided with the urging members 50 in the main-scan direction.

As illustrated in FIG. 12, a space 23 narrow in the main-scan direction and a space 24 wide in the main-scan direction vertically communicating with each other are formed in the engaged portion 20, and the engaged portion 20 includes a pair of stepped portions 25a and 25b between the space 23 and the space 24. The pair of engagement pieces 59a and 59b of the urging member 50 are inserted into the narrow space 23 of the engaged portion 20. The pair of engagement pieces 59a and 59b are elastically deformed in directions approaching each other. The pair of engagement pieces 59a and 59b reach the wide space 24, and force to return to the original state causes the pair of engagement pieces 59a and 59b to abut and engage with the stepped portions 25a and 25b. In this state, the force of the pair of engagement pieces 59a and 59b to return to the original state is converted to force toward the inside of the engaged portion 20 when the pair of engagement pieces 59a and 59b abut the stepped portions 25a and 25b. Therefore, the body portion 51 of the urging member 50 is urged downward. The positioning pieces 60 of the urging member 50 are inserted into the positioning holes 21, and the urging member 50 is accurately positioned in the main-scan direction and the sub-scan direction of the frame 10.

When the urging member 50 is mounted on the frame 10, the abutment portion 52 of the urging member 50 abuts the plate member 42b of the light condenser 40 as illustrated in FIG. 1. Specifically, the first support surface 54a of the first support portion 53a abuts the upper surface of the plate member 42b of the light condenser 40, and the second support surface 54b of the second support portion 53b abuts the outer surface of the plate member 42b. The wall surface 57 of the wall portion 56 also abuts the outer surface of the plate member 42b. The wall surface 57 abuts the light condenser 40 in a range across a center C in the vertical dimension of the light condenser 40, and the light condenser 40 is supported in the light condenser housing portion 16 without an inclination.

Since the body portion 51 of the urging member 50 is urged downward, the light condenser 40 is urged toward the frame 10 through the first support portion 53a and fixed. The abutment portion 52 abuts the plate member 42b by avoiding the rod lenses 41, and this prevents obstructing the optical path of the light condenser 40.

After the engagement portions 58 of the urging members 50 are engaged with the engaged portions 20 of the frame 10, the pressing portion 94 stops sucking the urging members 50 to release the urging members 50. Subsequently, the vertical driving portion 93 raises the plurality of pressing portions 94, and mounting of the urging members 50 on the frame 10 is finished.

When step 3 is finished, the placing table 80 is conveyed to the next stage.

### (Step 4)

Step 4 is a light guide mounting step of mounting the light guide 33 on the light guide housing portion 14.

An automatic assembly machine installed in the stage of step 4 performs the work of step 4.

In step 4, the light guide 33 is inserted toward the light guide housing portion 14 of the frame 10 from above, and the locking claws 15 are elastically deformed in a direction in which the opening of the light guide housing portion 14 expands. The light guide 33 is inserted into the light guide housing portion 14, and the locking claws 15 return to the original state to engage with the light guide 33. In this state, the incident surface 35 of the curved portion 34 of the light guide 33 and the light source 31 face each other.

When step 4 is finished, the placing table 80 is conveyed to the next stage.

### (Step 5)

Step 5 is a frame inversion step of vertically inverting the frame 10.

An automatic assembly machine installed in the stage of step 5 performs the work of step 5.

In step 5, both ends of the frame 10 in the longitudinal direction are grasped to lift the frame 10 upward from the placing table 80. Next, the frame 10 is rotated 180° about the axis of the frame 10 in the longitudinal direction, and the frame 10 is placed again on the placing table 80. In this case, the frame 10 is brought close to the placing table 80 as in step 1, and the pins 81a and 81b are inserted into the insertion holes 28a and 28b, respectively, to place the inverted frame 10 on the placing table 80.

### (Step 6)

Step 6 is a sensor substrate housing step of housing the sensor substrate 45 in the substrate housing portion 22 of the frame 10.

In step 6, the sensor substrate 45 is inserted toward the substrate housing portion 22 of the inverted frame 10 from above to house the sensor substrate 45 in the substrate housing portion 22. An automatic assembly machine installed in the stage of step 6 performs the work of step 6.

When step 6 is finished, the placing table 80 is conveyed to the next stage.

### (Step 7)

Step 7 is a holding member mounting step of mounting the holding members 70 on the frame 10.

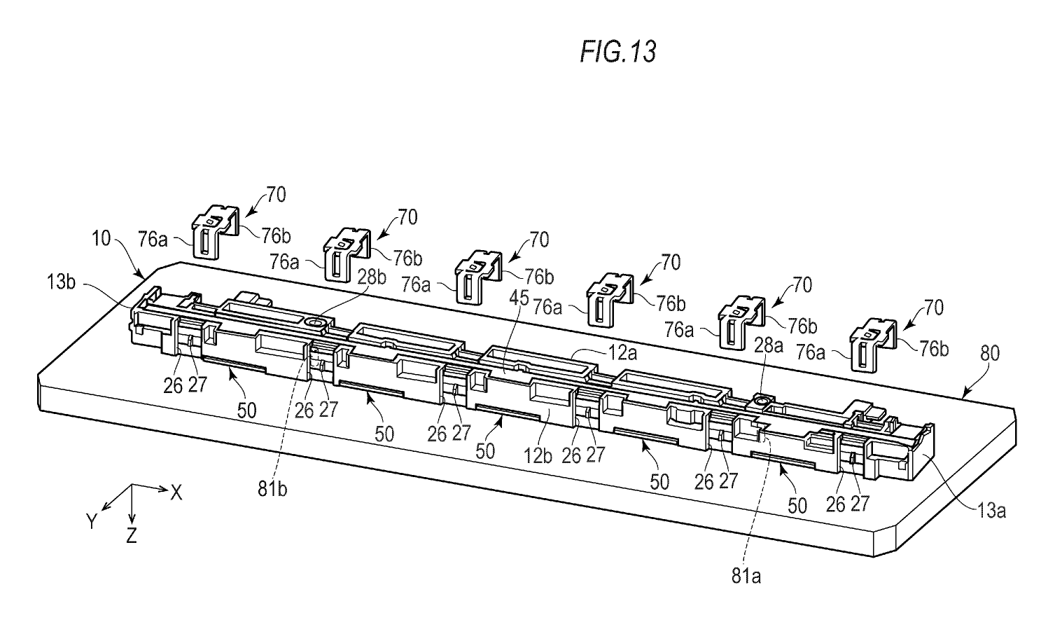

FIG. 13 is a view illustrating an example of the holding member mounting step.

An automatic assembly machine installed in the stage of step 7 performs the work of step 7. Note that the automatic assembly machine can be an assembly machine having functions as in FIGS. 10 and 11.

In step 7, the pairs of sandwiching portions 76a and 76b of the plurality of holding members 70 sandwich both sides of the fitting groove portions 26 of the frame 10, and the pairs of sandwiching portions 76a and 76b are pressed toward the frame 10 to engage the holding holes 77 of the sandwiching portions 76a and 76b with the held portions 27. The plurality of holding members 70 can be mounted on the frame 10 to hold the sensor substrate 45 housed in the substrate housing portion 22. In this way, the plurality of holding members 70 can be mounted on the frame 10 at the same time in step 7, and the assembly can be efficient.

Here, the state in which the holding member 70 is mounted on the frame 10 will be described with reference to FIG. 1. As illustrated in FIG. 1, the substrate urging portion 72 urges the lower surface of the sensor substrate 45 housed in the substrate housing portion 22 upward through the projections 73. The projections 73 urge the sensor substrate 45 at positions away from directly under the image sensor 48, and this can prevent imposing a load on the image sensor 48. The mounting surface 46 of the sensor substrate 45 and the frame 10 come into contact with each other above the projections 73, and the rigid frame 10 can receive the urging force of the substrate urging portion 72.

The image sensor unit 1 can be manufactured through steps 1 to 7 described above.

Next, operation of the image sensor unit 1 configured as described above will be described.

The image sensor unit 1 causes the LED chips 32 of the light source 31 to sequentially emit light. As illustrated in FIG. 1, the light guide 33 emits the light from the light source 31 to the lower surface of the original P as indicated by an arrow L. Therefore, the light is linearly emitted to the original P throughout the reading line S (main-scan direction). The light emitted from the light guide is reflected by the original P, and the reflected light is focused on the image sensor 48 through the light condenser 40. The image sensor 48 can convert the focused light to an electric signal to read the image on the lower surface of the original P.

The image sensor 48 reads the light from the original P for one scan line to complete the reading operation of one scan line of the original P in the main-scan direction. After the reading operation of one scan line is finished, the reading operation of next one scan line is performed in the same way as the operation described above along with relative movement of the original P in the sub-scan direction. In this way, the image sensor unit 1 repeats the reading operation of one scan line while moving in the sub-scan direction to sequentially scan the entire surface of the original P to read the image.

As described, according to the manufacturing method of the present embodiment, the assembly machine 90 in the urging member mounting step presses the plurality of urging members 50 against the frame and mounts the plurality of urging members 50 on the frame 10 such that the light condenser 40 is urged toward the frame 10 by the plurality of urging members 50 and fixed. Therefore, the light condenser is fixed to the frame 10 through the urging members 50 pressed and mounted by the assembly machine 90, and the light condenser 40 can be easily assembled to the frame 10. In this case, an adhesive for assembling the light condenser 40 is not necessary, or the amount of adhesive can be reduced even if the adhesive is also used. Therefore, the management of the adhesive or the time for curing the adhesive can be reduced, and the production efficiency of the image sensor unit 1 can be improved.

Although the urging members 50 are pressed against the frame 10 in the case described in the present embodiment, any manufacturing method can be adopted as long as the urging members 50 are pressed relative to the frame 10. More specifically, the frame 10 may be pressed against the urging members 50, or the frame 10 and the urging members 50 may be brought close to each other and pressed against each other.

According to the manufacturing method of the present embodiment, the pressing portions 94 of the assembly machine 90 hold the plurality of urging members 50 and press the plurality of urging members against the frame 10 to mount the plurality of urging members 50 on the frame 10 all at once. Therefore, the production efficiency of the image sensor unit 1 can be improved. The plurality of urging members 50 can be mounted on the frame 10 at the same time or substantially at the same time, and the production efficiency of the image sensor unit 1 can be further improved.

According to the manufacturing method of the present embodiment, the plurality of pressing portions 94 hold the urging members 50 and press the urging members 50 against the frame 10. The plurality of pressing portions 94 release the urging members 50 after the engagement portions 58 of the urging members 50 are engaged with the engaged portions 20 of the frame 10. Therefore, even when the urging members 50 are released, the engagement portions 58 of the urging members 50 and the engaged portions 20 of the frame 10 are engaged. This can prevent separation of the urging members 50 from the frame 10.

According to the manufacturing method of the present embodiment, the frame 10 is conveyed from the light condenser housing step to the urging member mounting step while the frame 10 is placed on the placing table 80. This can prevent a scratch or breakage of the frame 10, compared to when the frame 10 is directly conveyed.

According to the manufacturing method of the present embodiment, the placing table 80 includes two pins 81a and 81b, and the frame 10 includes the insertion holes 28a and 28b. The pins 81a and 81b can be inserted into the insertion holes 28a and 28b to improve the positioning accuracy of the frame 10 relative to the placing table 80. Note that the placing table 80 may include the insertion holes 28a and 28b, and the frame 10 may include the pins 81a and 81b.

According to the manufacturing method of the present embodiment, the insertion hole 28b and the pin 81b can relatively move in the longitudinal direction of the frame 10 when the pin 81b is inserted into the insertion hole 28b. More specifically, there is a clearance between the insertion hole 28b and the pin 81b in the longitudinal direction of the frame 10. Therefore, the pin 81b can be easily inserted into the insertion hole 28b even if the frame 10 is expanded or contracted due to an accuracy error of the frame 10 or due to the environment temperature.

### Second Embodiment

An image sensor unit 2 of the present embodiment can be brought close to the platen glass 104 as a transparent plate to prevent dust from entering the frame 10 and improve the reading accuracy. To prevent the urging members 50 from coming into contact with the platen glass 104, the image sensor unit 2 includes sliding portions 130 that come into contact with the platen glass 104 to slide. The configuration and the manufacturing method of the image sensor unit 2 of the present embodiment are the same as the configuration and the manufacturing method of the image sensor unit 1 of the first embodiment except for the sliding portions 130, and the description will be appropriately omitted.

Next, the configuration of the image sensor unit 2 will be described with reference to the drawings.

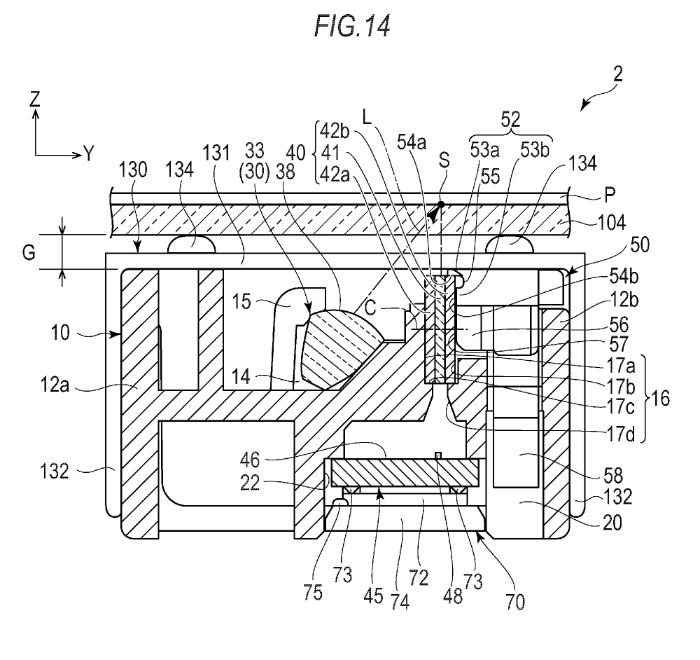

FIG. 14 is a sectional view of the image sensor unit 2 cut in the sub-scan direction.

The image sensor unit 2 includes a plurality of (for example, two) sliding portions 130 in addition to the constituent members of the image sensor unit 1 of the first embodiment.

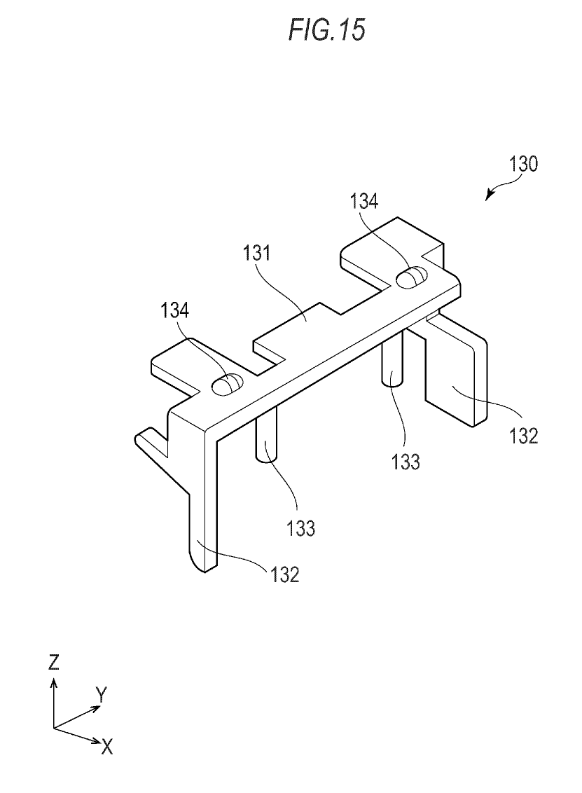

FIG. 15 is a perspective view illustrating a configuration of the sliding portion 130.

The sliding portions 130 are attached to the side wall portions 13a and 13b on both sides of the frame in the longitudinal direction and come into contact with the platen glass 104 to slide along the platen glass 104 according to the movement of the image sensor unit 2. The sliding portion 130 is formed in a substantially C-shape as viewed in the main-scan direction and includes a sliding body portion 131 and a pair of leg portions 132. The sliding portion 130 is formed by, for example, a resin material.

The sliding body portion 131 is planar and includes positioning pieces 133 on the lower surface and sliding convex portions 134 on the upper surface.

A plurality of (for example, two) positioning pieces 133 are formed at an interval in the sub-scan direction of the sliding body portion 131 and extend downward from the sliding body portion 131. The positioning pieces 133 are inserted into the holes 18 of the side wall portions 13a and 13b of the frame 10 to attach and position the sliding portions 130 relative to the frame 10. The pair of leg portions 132 are positioned across the frame 10, and the lower surface of the sliding body portion 131 comes into contact with the upper surfaces of the wide wall portions 13a and 13b. The pair of leg portions 132 may be engaged with the outer wall portions 12a and 12b of the frame 10 to prevent the sliding portions 130 from being easily removed from the frame 10.

A plurality of (for example, two) sliding convex portions 134 are formed at an interval in the sub-scan direction of the sliding body portion 131 and protrude upward from the sliding body portion 131. The upper surfaces of the sliding convex portions 134 are curved surfaces to allow smooth sliding along the platen glass 104.

As illustrated in FIG. 14, the upper ends of the urging members 50 are lower than the upper ends of the sliding convex portions 134 of the sliding portions 130 when the sliding portions 130 are attached to the frame 10. Therefore, when the image sensor unit 2 is assembled to the image reading apparatus, only the sliding convex portions 134 of the sliding portions 130 come into contact with the platen glass 104, and the urging members 50 are separated from the platen glass 104. A distance between the urging members 50 and the platen glass 104 is longer than a distance between the sliding convex portions 134 and platen glass 104. The sliding portions 130 are attached to the side wall portions 13a and 13b of the frame 10, and the sliding portions 130 are positioned in areas where the light condenser is not arranged in the longitudinal direction of the frame 10, that is, outside of the reading area. Therefore, there is no member in the image sensor unit 2 that comes into contact with the platen glass 104 in the reading area.

As illustrated in FIG. 14, a gap G between the frame 10 and the platen glass 104 in the present embodiment is smaller than in the first embodiment, and the image sensor unit 2 is brought close to the platen glass 104. Therefore, the image sensor unit 2 can prevent dust from entering the frame 10 from between the image sensor unit 2 and the platen glass 104, without a cover member such as a sealing plate on the upper surface of the frame 10. Although the urging members 50 may come into contact with the platen glass 104 by bringing the image sensor unit 2 close to the platen glass 104, the image sensor unit includes the sliding portions 130 coming into contact with the platen glass 104, and this prevents the urging members 50 from coming into contact with the platen glass 104.

The image sensor unit 2 can be applied to a discriminating apparatus that discriminates an image or authenticity information and to a reading apparatus such as an image scanner used in a printing device. Moving means in the reading apparatus changes relative positions of the image sensor unit 2 and the transparent plate by moving the image sensor unit 2 relative to the transparent plate, moving the transparent plate relative to the image sensor unit 2, or moving both the transparent plate and the image sensor unit 2, and the reading apparatus performs reading. In this case, the image sensor unit 2, more specifically, the urging members 50, does not come into contact with the reading area of the transparent plate, and the image sensor unit 2 can be brought close to the transparent plate without damaging the reading area of the transparent plate.

Note that the automatic assembly machine can also be used in the present embodiment to attach the sliding portions 130 to the frame 10.

Although the present invention has been described along with the embodiments, the present invention is not limited to the embodiments, and changes and the like can be made within the scope of the present invention.

Although the pressing portions 94 of the assembly machine 90 have a function of holding the urging members 50 and a function of pressing the urging members 50 against the frame 10 in the urging member mounting step in the description of the embodiments, the arrangement is not limited to this. For example, members for holding the urging members 50 to temporarily place the urging members 50 in the engaged portions 20 of the frame 10 and members for pressing the urging members 50 against the frame 10 may be different.

Although the curved portion 34 and the linear portion 37 are integrally formed on the light guide in the description of the embodiments, the arrangement is not limited to this, and a light guide including only the linear portion 37 may be used. When the light guide including only the linear portion 37 is used, the incident surface of the light guide is orthogonal to the main-scan direction. Therefore, the light source is arranged to face the incident surface of the light guide such that the light emission surface is orthogonal to the main-scan direction.

Although the illumination portion 30 includes the light source 31 and the light guide 33 in the description of the embodiments, the arrangement is not limited to this. For example, as in an LED array, the light source 31 may be arranged in the main-scan direction to linearly illuminate the original P.

Although the image sensor unit 1 includes the illumination portion 30 in the description of the embodiments, the arrangement is not limited to this. The image sensor unit 1 may not include the illumination portion 30.

Although the engagement portions 58 of the urging members 50 are elastically deformed, and the engaged portions 20 of the frame 10 are not elastically deformed in the description of the embodiments, the arrangement is not limited to this. More specifically, it is only necessary that at least either the engagement portions 58 or the engaged portions 20 are elastically deformed and that the engagement portions 58 are engaged with the engaged portions 20. Furthermore, the engagement portion 58 may include only one engagement piece instead of the pair of engagement pieces 59a and 59b.

Although the urging members 50 urge and fix the light condenser 40 to the frame 10 from the light entering side of the light in the description of the embodiments, the arrangement is not limited to this. For example, if the light condenser 40 is inserted into the light condenser housing portion 16 of the frame 10 from below and housed in the light condenser housing portion 16, the urging members 50 can urge and fix the light condenser 40 to the frame 10 from the light emission side of the light.

Although the insertion holes 28a and 28b of the frame 10 are formed to penetrate from the upper surface to the lower surface in the embodiments, the arrangement is not limited to this, and middle parts of the holes may be closed. Therefore, bottomed insertion holes 28a and 28b may be formed on the upper surface and the lower surface of the frame 10.

Although the sliding portions 130 as separate bodies are attached to the frame 10 in the second embodiment, the arrangement is not limited to this, and the sliding convex portions 134 may be integrally molded on the frame 10.

According to the present invention, the light condenser can be easily mounted on the frame.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. A manufacturing method of a sensor unit, the sensor unit comprising: a rod-shaped light condenser that condenses light from an illuminated object; a frame that houses the light condenser; and a plurality of urging members that urge the light condenser toward the frame and mount the light condenser on the frame, the manufacturing method comprising:
a light condenser housing step of housing the light condenser in the frame; and
an urging member mounting step of pressing, by an assembly machine, the plurality of urging members against the frame.

2. The manufacturing method of the sensor unit according to claim 1, wherein
the assembly machine comprises a plurality of pressing portions, and
the plurality of pressing portions hold the urging members and press the plurality of urging members against the frame.

3. The manufacturing method of the sensor unit according to claim 2, wherein
the urging members comprise engagement portions,
the frame comprises engaged portions with which the engagement portions are engaged,
the plurality of pressing portions hold the urging members and press the urging members against the frame, and the plurality of pressing portions release the plurality of urging members after the engagement portions are engaged with the engaged portions.

4. The manufacturing method of the sensor unit according to claim 1, further comprising
a step of placing the frame on a placing table before the light condenser housing step, wherein
the frame placed on the placing table is conveyed from a stage of the light condenser housing step to a stage of the urging member mounting step.

5. The manufacturing method of the sensor unit according to claim 4, wherein
one of the frame and the placing table comprises two insertion portions at separate positions,
the other of the frame and the placing table comprises two inserted portions into which the two insertion portions are inserted, and the insertion portions are inserted into the inserted portions when the frame is placed on the placing table.

6. The manufacturing method of the sensor unit according to claim 5, wherein
an opening of one of the two inserted portions is long in a longitudinal direction of the frame.

7. A reading apparatus comprising: a transparent plate for placing an illuminated object; and a sensor unit that reads the illuminated object through the transparent plate,
the sensor unit comprising:
a rod-shaped light condenser that condenses light from the illuminated object;
a frame that houses the light condenser; and
a plurality of urging members that urge the light condenser toward the frame and mount the light condenser on the frame,
the reading apparatus comprising
moving means for moving at least one of the transparent plate and the sensor unit, wherein
the frame comprises sliding convex portions between a position of arrangement of the light condenser and an end, and
a distance between the urging members and the transparent plate is longer than a distance between the sliding convex portions and the transparent plate.
